(19) United States
(12) Patent Application Publication
(10) Pub. No.: US 2008/0004065 A1
(43) Pub. Date: Jan. 3, 2008

(54) Heater control system for wireless AP

(75) Inventor: Shih-Yi Chen, Jhubei City (TW)

Correspondence Address: BIRCH STEWART KOLASCH & BIRCH, PO BOX 747, FALLS CHURCH, VA, 22040-0747, US

(73) Assignee: Accton Technology Corporation

(21) Appl. No.: 11/475,050

(22) Filed: Jun. 27, 2006

(51) Int. Cl. H04M 1/00

(52) U.S. Cl. 455/550.1

(57) ABSTRACT

The present invention provides a wireless AP with a heater control system. The wireless AP comprises a cold reset device, which is activated to warm up the wireless AP when the temperature around the wireless AP is under a very low temperature. Therefore, the wireless AP of the present invention can be setup in outdoor under very cold temperature. The heater control system comprises a power supply for providing voltage, a thermal sensor connected to the power supply, and a voltage comparator connected with said thermal sensor to compare the signal detected by said thermal sensor, and a cold reset is connected to said voltage comparator, wherein said cold reset will be power on based on the comparing result of said voltage comparator.

### BACKGROUND OF THE INVENTION

1. Field of the Invention

This invention relates to an outdoor wireless AP device, and particularly, to a wireless AP with heater control system.

2. Description of the Prior Art

With advancement in communication and network technology, a wired network environment using wired media such as coaxial or optical cables is evolving into a wireless one using wireless signals in various frequency bands. Wireless communication systems have been developed rapidly. No matter in the business or in the family, the wireless communication systems are everywhere in people's life and are widely employed to provide various types of communication such as voice, data, and so on.

With the transition from wired to wireless technology, a computing device that contains a wireless interface module, enables mobility, and perform specific functions by processing various information is being developed and wireless technologies that enable effective communication between wireless device on a wireless network are emerging. Usually, an access point (AP) is a device for providing wireless network. And more and more network is depending on AP.

Sometimes, AP will be setup in a harsh position, for example in the outdoor. And the temperature may change variously according to the weather. It is a challenge for an AP device to be placed under very cold condition or environment, for example at −40 [symbol] temperature. The electrode elements of the AP will be failed, damaged or malfunctioned. The disadvantage of the typical AP is that they can not work normally under low temperature.

### SUMMARY OF THE INVENTION

The main purpose of the present invention is to provide an AP device with heater system. The advantage of the present invention is that the wireless AP comprises a heater control system, therefore it can be setup in outdoor under very cold temperature or environment.

Another advantage of the present invention is that hysteresis is provided in the heater control system of the wireless AP, therefore the heater is activated when the temperature is below and above specific temperature range, therefore the heater will not be turned on and off rapidly or frequently.

The present invention provides a wireless communication device with thermal sensor, comprises: a power supply for providing voltage, the power supply includes a power source, for example, 10V DC voltage; a thermal sensor is connected to the power supply to sense the temperature of said wireless communication device, the thermal sensor includes a temperature-voltage transformer, and the thermal sensor may measure or detect the temperature of the device to allow the device to be operated under a severe environment; a voltage comparator connected with said thermal sensor to compare the signal detected by said thermal sensor, and voltage comparator comprises an OP amplifier; and a cold reset connected to said voltage comparator, wherein said cold reset will be power on based on the comparing result of said voltage comparator.

Another purpose of the present invention is to provide a wireless communication device, comprises a voltage divider, with PTC component for transforming temperature signal into voltage output; a voltage comparator with hysteretic circuits connected to the voltage divider to compare said voltage output with a predetermined value and to maintain the current status of said wireless communication device within a parameter range, the voltage comparator comprises an adjustable precision zener shunt regulator; a control circuit connected to said voltage comparator; a power supply of heater connected to said control circuit; and a heater connected to said control circuit, wherein said control circuit is used to control the status of said heater based on the comparison result of said voltage comparator.

Besides, the present invention provides a wireless communication device, comprises: a first DC voltage, 10 V DC, with a first resistor, 1K/0.25 W ohm resistor (for instance), for providing power supply, and the other end of the first resistor is connected to ground through a zener diode; a temperature-voltage transformer with first input port connected to the first resistor, and the third port connected to ground, and the second port connected to ground through a capacitor; an OP amplifier with a second resistor, 820 ohm resistor, is connected between a negative input port of the OP amplifier and the second port of the temperature-voltage transformer, the positive input port connected to ground through a third resistor, and the positive input port connected to a third input port of the OP amplifier through a fourth resistor, the fourth input port of the OP amplifier connected to ground, and the output port of the OP amplifier connected to a fifth resistor; a second DC voltage, 3.3V DC, connected to the third input port of the OP amplifier, and connected to a sixth resistor; a transistor, including a base connected to the fifth resistor, a emitter connected to ground, and a collector connected to the sixth resistor, 5K ohm resistor; and a cold reset is connected to the collector of the transistor. And the wireless communication device further comprises a seventh resistor connected between the output and the positive input port.

The present invention also provides a wireless communication device, comprises: a heater includes substantially two input ports, and the second input port is connected to ground; a MOSFET includes a drain, a source and a gate, wherein the drain is connected to the first input port of the heater, and the source is connected to the drain through a first resistor, the gate is connected to the drain through a second resistor; a first power supply connected to the source of the MOSFET; an adjustable precision zener shunt regulator with anode connected to ground and cathode connected to the gate of the MOSFET, and reference of the adjustable precision zener shunt regulator is connected to the first input port of the heater through a third resistor, the reference of the adjustable precision zener shunt regulator is connected to ground through a capacitor parallel with a fourth resistor; a PTC, is connected to the reference of the adjustable precision zener shunt regulator; and a second power supply, connected to the PTC.

### BRIEF DESCRIPTION OF THE DRAWINGS

The above objects, and other features and advantages of the present invention will become more apparent after reading the following detailed description when taken in conjunction with the drawings, in which:

FIG. 1 is a block diagram of a thermal sensor of the present invention.

FIG. 2 is a block diagram of a heater control system of the present invention.

FIG. 3 is a circuit diagram of a thermal sensor of the present invention.

FIG. 4 is a circuit diagram of a heater control system of the present invention.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims. Then, the components of the different elements are not shown to scale. Some dimensions of the related components are exaggerated and meaningless portions are not drawn to provide clearer description and comprehension of the present invention.

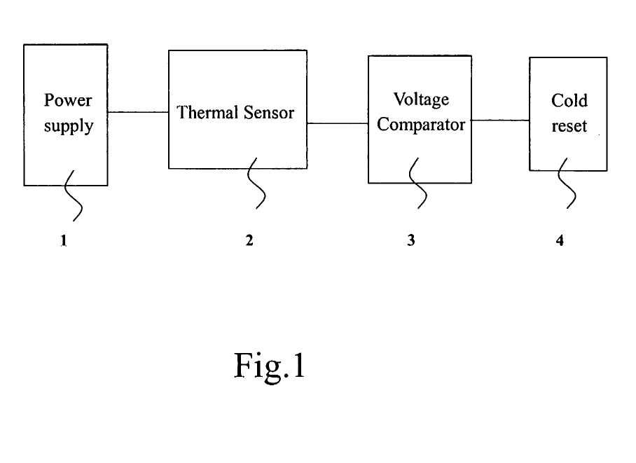

FIG. 1 shows a block diagram of a heater control system of a wireless AP according to the present invention. The heater sensor comprises: a power supply 1, a thermal sensor 2 coupled to the power supply 1. A voltage comparator 3 is next coupled to the thermal sensor 2 and a cold reset 4 is subsequently connected to the voltage comparator 3. The power supply 1 is provided to supply the power to the thermal sensor 2 of the present invention. The thermal sensor 2 is used for sensing the temperature around of the wireless AP around the switch. The thermal sensor 2 will transmit a signal into the voltage comparator 3. The voltage comparator 3 is employed to compare the voltage with a preset value, and sending a signal to cold reset 4 of the AP based on the comparison result, which turns on a heater to warm up the AP. On the other way, the circuits give a reset signal when thermal sensor 2 output indicates the temperature around the CPU of the wireless AP is below a certain temperature, for example, −40 degree centigrade.

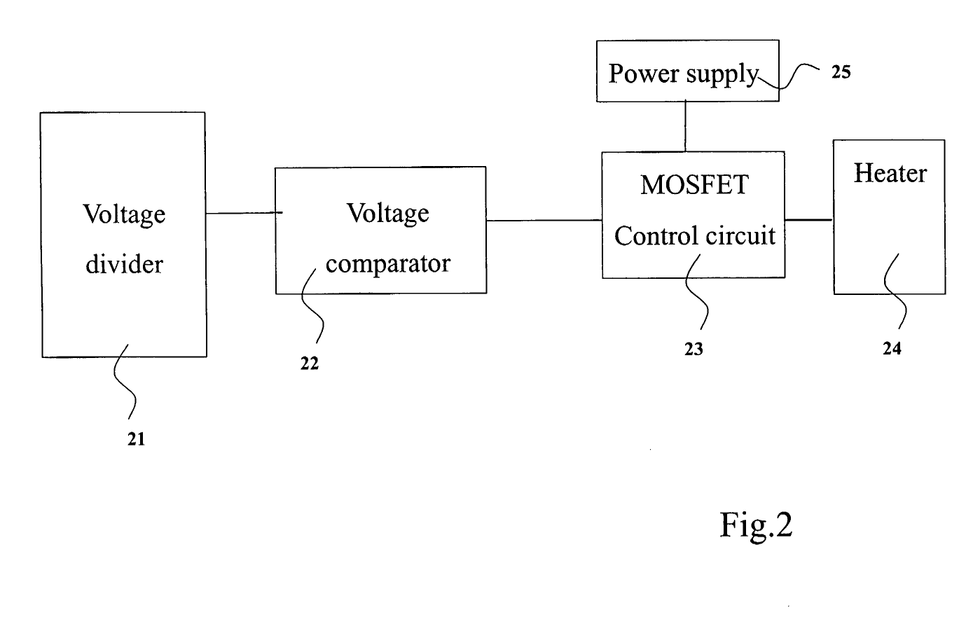

Another embodiment of the present invention is shown in FIG. 2. The heater control system of a wireless AP of the present invention comprising: voltage divider 21 with PTC (positive temperature coefficient) resistor, a voltage comparator 22 with hysteretic circuits, control circuit 23 (for example MOSFET circuits), power supply 25, and the heater 24. The voltage divider 21 with PTC component resistor is electrically coupled to the voltage comparator 22 with hysteretic circuits. The voltage comparator 22 with hysteretic circuit is electrically coupled to MOSFET control circuit 23 and the power supply 25 of the heater 24 is electrically coupled to the MOSFET control circuit 23, and finally, the MOSFET control circuit 23 is electrically coupled to heater 24.

The resistor of PTC varies according to the temperature, therefore the voltage divider 21 with PTC component sent a voltage according to the temperature into voltage comparator 22 with hysteretic circuits. Namely, the higher the temperature is, the larger the resistance is. Thus, the voltage across the resistor is lower. The voltage comparator 22 with hysteretic circuits output a signal to the MOSFET control circuit 23 to control the heater 24. The hysteretic circuits 22 may maintain the status when the operation temperature within a predetermined range to prevent the power of the heater 24 from being altered frequently. The voltage comparator 22 transmits a signal to the MOSFET control circuit 23 when the input voltage is lower than or exceeds a hysteretic value. The power supply 25 is employed to provide power to the heater 24.

The circuitry provides the power control of heater so that the power consumption and thermal control can be fulfilled. To prevent from the un-wanted switching ON/OFF under certain temperature, the control signal is given through hysteretic circuits.

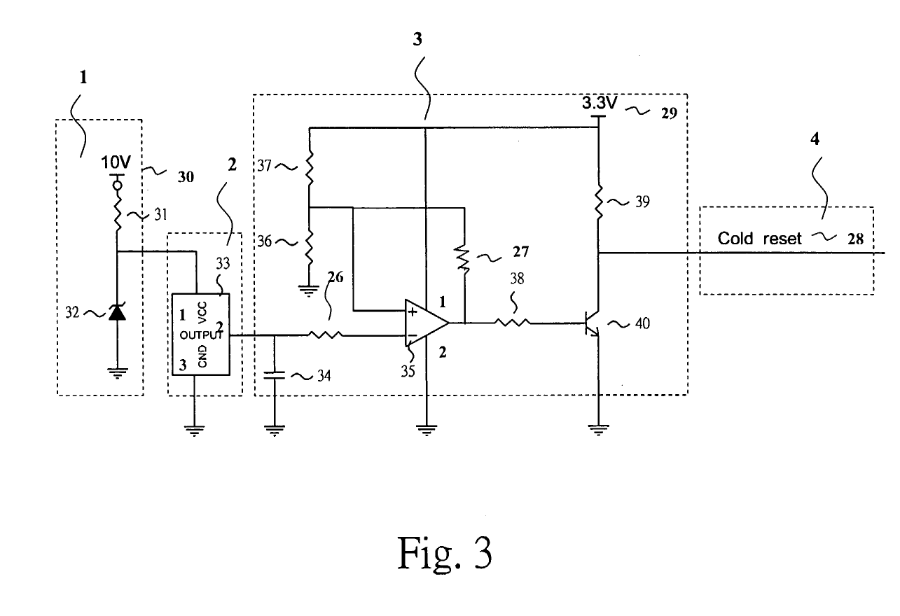

FIG. 3 shows detail circuits of the thermal sensor system of a wireless AP according to the present invention in FIG. 1. The circuit comprises a DC power supply 30, a resistor 31, an adjustable precision zener shunt regulator diode 32, a temperature-voltage transformer 33 connects with the DC power supply 30. The temperature-voltage transformer 33 is used for transforming temperature signal into voltage output. The DC power supply 30 is 10V DC in the embodiment. The resistor 31 could be 1K/0.25 W ohm resistor for example.

The temperature-voltage transformer 33 has three ports, including one input port 1, one output port 2, and output port 3 connected to ground. A capacitor 34, for instance 0.1 uF capacitor, is connected to the output port 2 of temperature-voltage transformer 33, and passes through a resistor 26 and connect to the negative input port of the OP amplifier 35. The positive input port of the OP amplifier 35 is connected between resistor 37 and resistor 36. Another power supply 29, 3.3V DC, is electrically connected to the resistor 37 for providing the power supply of the OP amplifier 35. The power supply 29 is connected to port 1 of the OP amplifier 35, and port 2 of the OP amplifier 35 is connected to ground. The output port of the OP amplifier 35 is connected to a transistor 40 through a resistor 38. The transistor 40 is employed to turn on and off the cold reset 28. The emitter of the transistor 40 is connected to ground and the base is connected to resistor 38. The collector 3 is connected to the power supply 29 through a resistor 39.

Therefore, the temperature-voltage transformer 33 acts as the thermal sensor, which is used for detecting temperature and then transformed the signal into relative voltage output. The voltage output is subsequently transmitted into a comparator, constructing by an OP amplifier 35. If the input voltage of the OP amplifier 35 is lower than a specific temperature or voltage value, for example −40 [symbol] in the embodiment, the OP amplifier 35 outputs a signal to turn off the transistor 40. The cold reset 28 is activated when the temperature around CPU of the wireless AP is lower than a predetermined temperature, such as −40 [symbol] . Thus, the present invention may be operated under a severe environment.

Especially, a resistor 27 can be connected between the positive input port and the output port of the OP amplifier 35 forming a positive feedback in the comparator circuit. Therefore, the comparator circuit operates with hysteresis. The status of the cold reset 28 will not be altered within a predetermined voltage or temperature range, the cold reset 28 will not be turned on or off repeatedly or frequently to extend the lifetime of the device.

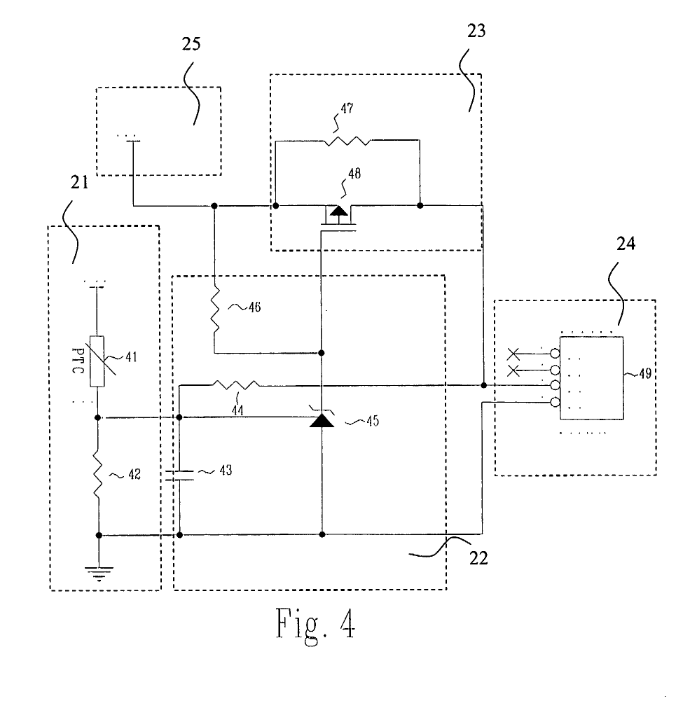

FIG. 4 shows a heater control with hysteresis circuit of the present invention in FIG. 2. A voltage 10V is provided into a MOSFET 48 for providing a power to turn on the heater 49. The heater 49 has two ports for example. A resistor 47 is connected between source and drain of MOSFET 48. A power supply, 10V DC is connected to the source of the MOSFET 48. A resistor 46 is connected between the source and gate of the MOSFET 48. The MOSFET 48 is used for switching on and off the heater 49. A positive temperature coefficient resistor 41 is electronically coupled with a 3.3V DC voltage 51 and further connected with a resistor 42. A capacitor 43 is connected to parallel with the resistor 42, and an OP amplifier 45 with input port 3 connected with resistor 42.

The positive temperature coefficient resistor 41 may alter the resistance depending on the temperature. The resistance of the PTC 41 increase when the temperature raises, and the resistance of the PTC decreases when the temperature decreases. The output voltage reduces when the temperature rises, and the MOSFET 48 is turned off because the gate voltage decreases. The heater 49 is turned off because the MOSFET 48 is turned off. Therefore the heater 49 is turned off when the temperature increases.

If the temperature decreases, the resistance of PTC 41 decreases, the output voltage increases. The MOSFET 48 is turned on because the gate voltage increases. Therefore, the heater 49 is turned on when the temperature decreases. The circuit in FIG. 4 has a positive feedback from the first input port of the heater 49 to the reference of adjustable precision zener shunt regulator 45 thereby causing hysteresis condition or phenomena, that is the status of the heater 49 will not be altered within a predetermined voltage or temperature range, the heater will not be turned on or off repeatedly or frequently to extend the lifetime of the device. A resistor 44 is connected between the first input port of the heater 49 and the reference of adjustable precision zener shunt regulator 45. In the present embodiment, the resistance of the resistor 44 is 330K ohm. And the resistance is selected for controlling the temperature hysteresis range.

Therefore according to above description, the present invention provides a thermal sensor connected with cold reset in a wireless communication device. The thermal sensor is used for sensing the temperature and transformed into a relative voltage value. Then, the voltage is sent into a comparator. If the voltage is lower than a preset value. The comparator output a signal to turn on a switch to turn on the cold reset.

According to second embodiment, a MOSFET is connected to a heater for controlling the heater. An adjustable precision zener shunt regulator is connecting to the gate of the MOSFET therefore the MOSFET is activated with a hysteresis. A PTC (positive temperature coefficient resistor) 41 is used for providing relative voltage into the reference of the adjustable precision zener shunt regulator 45. And the first input port of the heater is feedback into the reference of the adjustable precision zener shunt regulator 45, therefore the switch MOSFET 48 will be maintain the current status within a temperature range. Therefore the heater is also responsive to the MOSFET 48 to active in a range of temperature.

According to the above description, the present invention provides a wireless communication device with heater control. Therefore the AP may be setup in an outdoor place. When the temperature is lower than a preset temperature, a cold reset will be active to warm up the AP. According to another embodiment of the present invention, the present invention provides a wireless communication device with a heater control system. The heater is controlled with hysteresis, therefore the heater works when the temperature is lower than or above specific temperature. The advantage is that the heater will not be turn on or off repeatedly to increase the life time of the heater.

Although specific embodiments have been illustrated and described, it will be obvious to those skilled in the art that various modifications may be made without departing from what is intended to be limited solely by the appended claims.

What is claimed is:

1. A wireless communication device, comprises:
a power supply for providing voltage;
a thermal sensor connected to said power supply to sense the temperature of said wireless communication device;
a voltage comparator connected with said thermal sensor to compare the signal detected by said thermal sensor; and
a cold reset connected to said voltage comparator, wherein said cold reset will be power on based on the comparing result of said voltage comparator.

2. The wireless communication device in claim 1, wherein said thermal sensor includes a temperature-voltage transformer.

3. The wireless communication device in claim 1, wherein said voltage comparator comprises an OP amplifier.

4. A wireless communication device as in claim 1, wherein said power supply includes a first DC voltage with a first resistor for providing power supply, and the other end of the first resistor is connected to ground through a zener diode.

5. A wireless communication device as in claim 4, wherein said thermal sensor includes a temperature-voltage transformer, with first input port connected to the first resistor, and the third port connected to ground, and the second port connected to ground through a capacitor.

6. A wireless communication device as in claim 5, wherein said voltage comparator includes: an OP amplifier, with a second resistor connected between a negative input port of said OP amplifier and the second port of said temperature-voltage transformer, the positive input port connected to ground through a third resistor, and the positive input port connected to a third input port of said OP amplifier through a fourth resistor, the fourth input port of said OP amplifier connected to ground, and the output port of said OP amplifier connected to a fifth resistor; a second DC voltage connected to the third input port of said OP amplifier, and connected to a sixth resistor; a transistor, including a base connected to the fifth resistor, a emitter connected to ground, and a collector connected to the sixth resistor; and a seventh resistor is connected between the output port of said OP and the positive input port.

7. A wireless communication device, comprises:
a voltage divider with a PTC component for transforming temperature signal into voltage output;
a voltage comparator with hysteretic circuits connected to said voltage divider to compare said voltage output with a predetermined value and to maintain the current status of said wireless communication device within a parameter range;
a control circuit connected to said voltage comparator;
a power supply connected to said control circuit; and
a heater connected to said control circuit, wherein said control circuit is used to control the status of said heater based on the comparison result of said voltage comparator.

8. A wireless communication device in claim 7, wherein said voltage divider further comprising a second power supply, connected to said PTC component; a fourth resistor is connected between said PTC component and ground; and a second power supply, connected to said PTC component.

9. A wireless communication device in claim 8, wherein said control circuit comprises: an adjustable precision zener shunt regulator with anode connected to ground and cathode connected to the gate of said MOSFET, and reference of said adjustable precision zener shunt regulator is connected to the first input port of said heater through a third resistor, the reference of said adjustable precision zener shunt regulator is connected to ground through a capacitor parallel with a fourth resistor; and a MOSFET includes a drain, a source and a gate, wherein the drain is connected to the first input port of said heater, and the source is connected to the drain through a first resistor, the gate is connected to the drain through a second resistor.

10. A wireless communication device in claim 9, wherein said power supply of heater connects to the source of said MOSFET.

11. A wireless communication device in claim 9, wherein the voltage comparator comprises an adjustable precision zener shunt regulator.

12. A wireless communication device in claim 7, further comprises a seventh resistor connected between the output and the positive input port.
